(19) United States
(12) Patent Application Publication
(10) Pub. No.: US 2021/0081862 A1
(43) Pub. Date: Mar. 18, 2021

(54) SYSTEM FOR MANAGING A SHARED RESOURCE POOL

(71) Applicant: Lucas Parry, San Jose, CA (US)

(72) Inventor: Lucas Parry, San Jose, CA (US)

(21) Appl. No.: 17/023,104

(22) Filed: Sep. 16, 2020

Related U.S. Application Data
(60) Provisional application No. 62/901,181, filed on Sep. 16, 2019.

(51) Int. Cl. G06Q 10/06

(52) U.S. Cl. CPC G06Q 10/06311

(57) ABSTRACT

A method to allocate pooled resources, the method comprising accessing a database of wellness activities and selectively publishing the wellness activities to users with a predetermined frequency. A database of curated content is accessed and selectively publishing the generated content to users. A user is prompted to provide a contribution towards a pooled resource and to vote for a particular target category from a plurality of target categories for allocation of the pooled resource.

### PRIORITY APPLICATION

This application claims priority to U.S. Provisional Application Ser. No. 62/901,181, filed Sep. 16, 2019, the disclosure of which is incorporated herein in its entirety by reference.

### BACKGROUND

A number of charitable giving automation tools have recently emerged, particularly with the explosion of the Internet. However, they are still a large number of technical challenges presented by current tools and platforms that remain to be solved, particularly with respect to providing visibility to givers regarding the impact of contributions and also ease-of-use in directing charitable contributions to particular sources.

### BRIEF SUMMARY

An example, embodiment seeks simply to encourage more joy and generosity into the world by combining the power of community, storytelling, and technology with the science of generosity to help people increase their impact in the world and improve their lives.
Daily tips to cultivate generosity and increase joy in your everyday
Experience the power of a charitable “superfund” and help give away over $1 billion a year
Read and follow along with every story and project funded

The example systems include at least three components:

The Daily Glow: Receive daily notifications with short, easy-to-follow activities that are designed to help you cultivate radical generosity towards yourself, others, and the world. Track the results and measure the impact. On average. people report feeling 60% more joy after completing a #dailyglow.

Inspiring Storytelling: Be inspired by curated news, stories, video, blogs, and updates that put you in a good mood and make you want to celebrate life. Throw away all the negative vibes from your current news apps and social media feeds! The example programmatic resource allocation client 108 will keep you updated on all the good happening around the world, the latest grants, and updates from the Superfund, along with stories you care about and find interesting.

The Superfund: The Superfund is a whole new way to give that literally allows everyday people (like us) to have more impact in the world! Imagine experiencing the joy of philanthropy at a billionaire scale?
Turn your small donation into millions of dollars every month
Support 1000's of the best charities, doing the best work, all throughout the world
Follow the stories of every project funded.

“Superfunding” is a new category of charitable giving built on a community of people with shared values and interests, that combine their financial resources for greater impact. As such, a “superfund” may be understood to be an aggregated or pooled monetary resource.

Fund categories include: Eradicating extreme poverty; Quality education; Clean water and sanitation; The environment; Disaster relief; Innovation; Health and curing disease.

We believe in doing good, and that we should care for the earth and those within it. We value diversity, equality, and think everyone should have the opportunity to build a better life.

Here are some things we seek to change:
End to the “ugh.” That feeling you get when giving to charity and think your gift won't make much of a difference!
Boot depression. Since 2013 depression has risen 46% among millennials because we're surrounded by negativity, trapped by constant comparisons, and a societal rise in individualism and narcissism.
Close the black hole. When we give to charity, most of the time, we never hear the stories and therefore don't get to experience the joy of

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked computing environment 100 in which the present disclosure may be deployed, in accordance with some example embodiments.

FIG. 2 illustrates a databases 132, in accordance with one example.

FIG. 3 is a diagrammatic representation of a processing environment 300, in accordance with one example.

FIG. 4 is a flowchart illustrating a method 400 of resource allocation, in accordance with one example.

FIG. 5 illustrates a welcome user interface 500, in accordance with one example.

FIG. 6 illustrates a registration user interface sequence 600, in accordance with one example.

FIG. 7 illustrates a wellness activity user interface sequence 700, in accordance with one example.

FIG. 8 illustrates a notification user interface sequence 800, in accordance with one example.

FIG. 9 illustrates a curated content user interface 900, in accordance with one example.

FIG. 10 illustrates an allocation user interface sequence 1000, in accordance with one example.

FIG. 11 illustrates a curated content user interface 1100, in accordance with one example.

FIG. 12 illustrates a profile user interface 1200, in accordance with one example.

FIG. 13 illustrates a settings user interface 1300, in accordance with one example.

FIG. 14 illustrates a charity recommendation user interface 1400, in accordance with one example.

FIG. 15 illustrates an invitation user interface 1500, in accordance with one example.

FIG. 16 is a block diagram showing a software architecture within which the present disclosure may be implemented, according to an example embodiment.

FIG. 17 is a diagrammatic representation of a machine in the form of a computer system within which a set of instructions may be executed for causing the machine to perform any one or more of the methodologies discussed herein, in accordance with some example embodiments.

### DETAILED DESCRIPTION

According to some example embodiments, there is provided a charitable giving platform that leverages the power of community and storytelling to unlock radical generosity and joy.

The charitable giving platform provides a whole new way to give that's fun, satisfying, and addicting, allowing ordinary people to experience the joy of philanthropy (e.g., by supporting high-impact organizations, spurring innovation, funding new research, and solving some of humanities greatest challenges.

The charitable giving platform seeks to support a community of creators, adventurers, dreamers, and entrepreneurs who have the audacity to believe that generosity can change the world. Less than 1% of people will ever give away $1 million in an entire lifetime. But what if there was a technology platform that enabled a community to give over $1 billion a year to high-impact organizations solving some of humanity's greatest challenges?

All it would take is a community of 10 million people, each giving an average of $8.33 a month into a SUPERFUND. Then with the help of cool technology, make giving it all away fun, while being obsessive about telling every story of impact along the way.

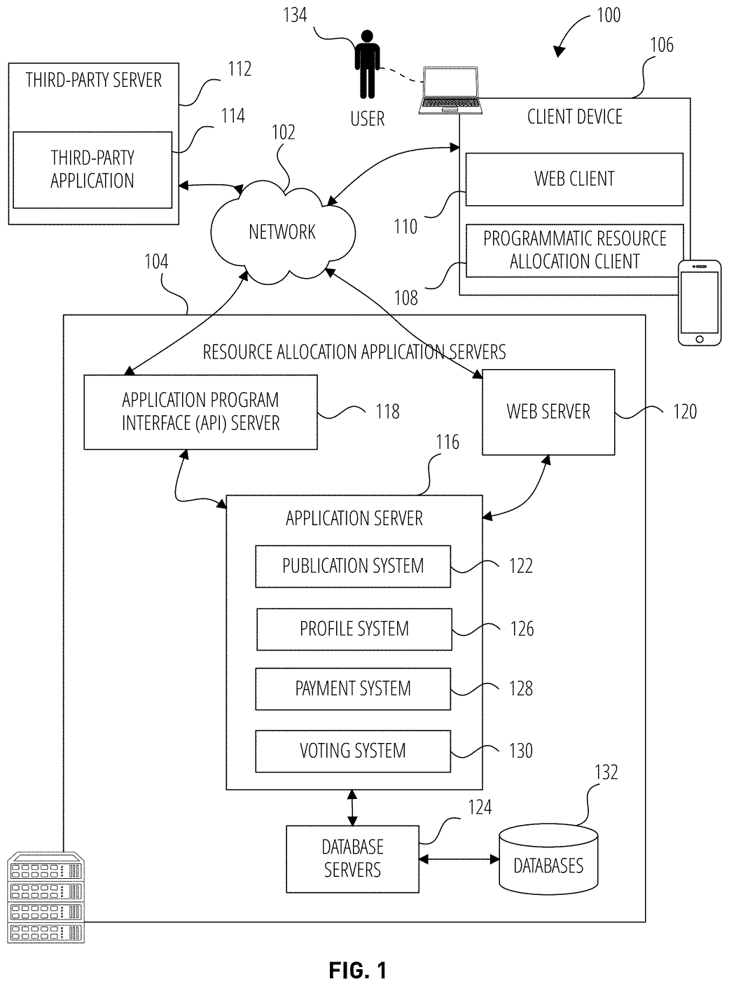

FIG. 1 is a diagrammatic representation of a networked computing environment 100 in which some example embodiments of the present disclosure may be implemented or deployed.

One or more resource allocation application servers 104 provide server-side functionality via a network 102 to a networked user device, in the form of a client device 106. A web client 110 (e.g., a browser) and a programmatic resource allocation client 108 (e.g., an “app”) are hosted and executed on the web client 110.

An Application Program Interface (API) server 118 and a web server 120 provide respective programmatic and web interfaces to resource allocation application servers 104. A specific application server 116 hosts a publication system 122, a profile system 126, a payment system 128, and a voting system 130, each of which includes components, modules and/or applications.

The web client 110 communicates with the publication system 122, the profile system 126, the payment system 128, and the voting system 130 via the web interface supported by the web server 120. Similarly, the programmatic resource allocation client 108 communicates with the systems of the application server 116 via the programmatic interface provided by the Application Program Interface (API) server 118. The third-party application 114 may, for example, be a payment processing application (e.g., Stripe) or a charity-rating system that provides assessments of charitable organizations (e.g., Charity Navigator, CharityWatch, or the Better Business Bureau).

The application server 116 is shown to be communicatively coupled to database servers 124 that facilitates access to an information storage repository or databases 132. In an example embodiment, the databases 132 includes storage devices that store information to be published and/or processed by the systems of the application server 116.

Additionally, a third-party application 114 executing on a third-party server 112, is shown as having programmatic access to the application server 116 via the programmatic interface provided by the Application Program Interface (API) server 118.

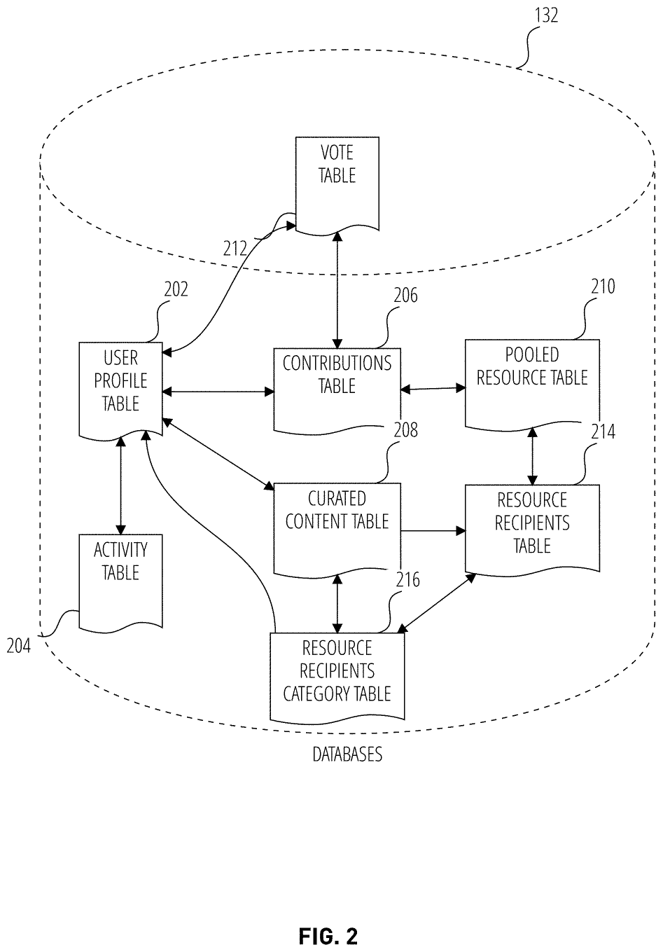

FIG. 2 is a diagrammatic representation of the databases 132, specifically shows a number of tables that may be maintained within the databases 132 to support the operation of the programmatic resource allocation client 108/resource allocation application servers 104

The tables include a user profile table 202 that stores user profile information regarding users (e.g., user 134) of the user interface flow networked computing environment 100 and a contributions table 206, which records contributions (e.g., monetary contributions) and contribution votes made by users for allocation by the programmatic resource allocation client 108/resource allocation application servers 104.

A pooled resource table 210 maintains records of pooled resources (e.g., pooled monetary contributions as recorded within the contributions table 206) received from multiple users of the programmatic resource allocation client 108, while a resource recipients table 214 stores records for resource recipients (e.g., charities) of the pooled resources.

A resource recipients category table 216 records various recipient categories (e.g., categories of charities, such as environmental, poverty, etc.) into which recipients may be categorized, with each of these categories being available for voting (or percentage allocation), as will be described in further detail below.

As activity table 204 stores a collection of wellness activities that may be classified according to type, difficulty, and level.

A curated content table 208 contains generated content that may also be categorized according to the various recipient categories of resource recipients category table 216, and that may also be directly related to the various resource recipients of resource recipients table 214. Content in the curated content table 208 may also be directly related to a particular user profile in the user profile table 202, based on expressed interests recorded in a user profile, or based on contribution information (or voting information), recorded for a particular user within the contributions table 206.

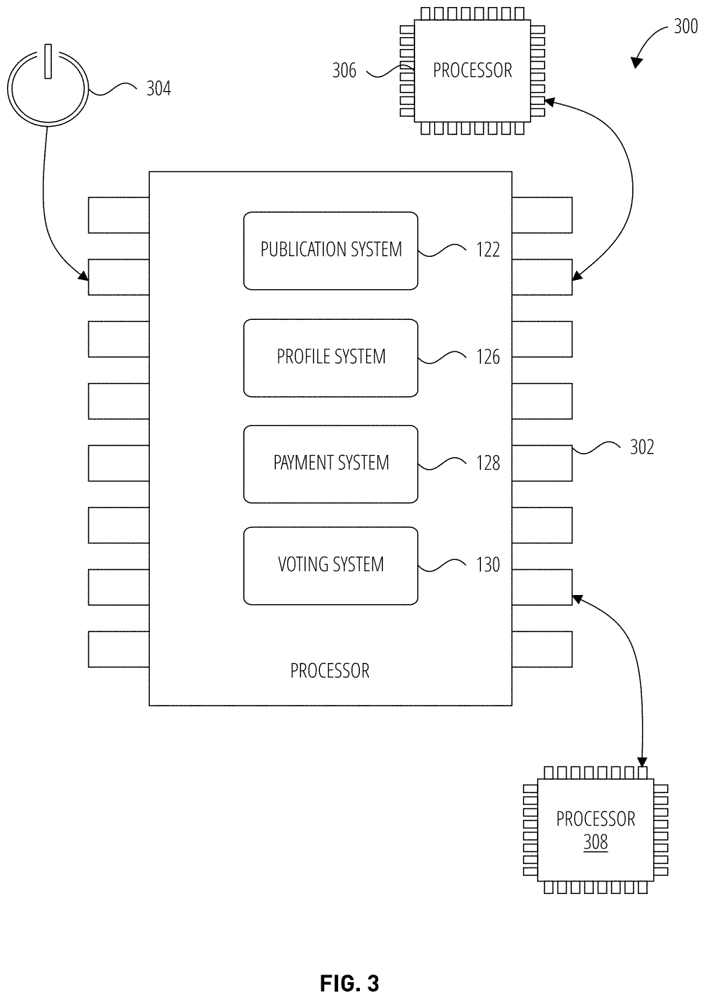

Turning now to FIG. 3, there is shown a diagrammatic representation of a processing environment 300, which includes the processor 306, the processor 308, and a processor 302 (e.g., a GPU, CPU, or combination thereof).

The processor 302 is shown to be coupled to a power source 304, and to include (either permanently configured or temporarily instantiated) systems, namely the publication system 122, the profile system 126, the payment system 128, and the voting system 130. The publication system 122 operationally published content (e.g., from a curated content table 208), the profile system 126 operationally creates and maintains a user profile (e.g., as within a user profile table 202), and the payment system 126 handles contributions (e.g., as recorded in contributions table 206) and directs them to resources (e.g., a managed with a pooled resource table 210). A voting system 130 receives votes (e.g., percentage allocation votes) and records this information in the resource recipients category table 216. As illustrated, the processor 302 is communicatively coupled to both the processor 306 and processor 308.

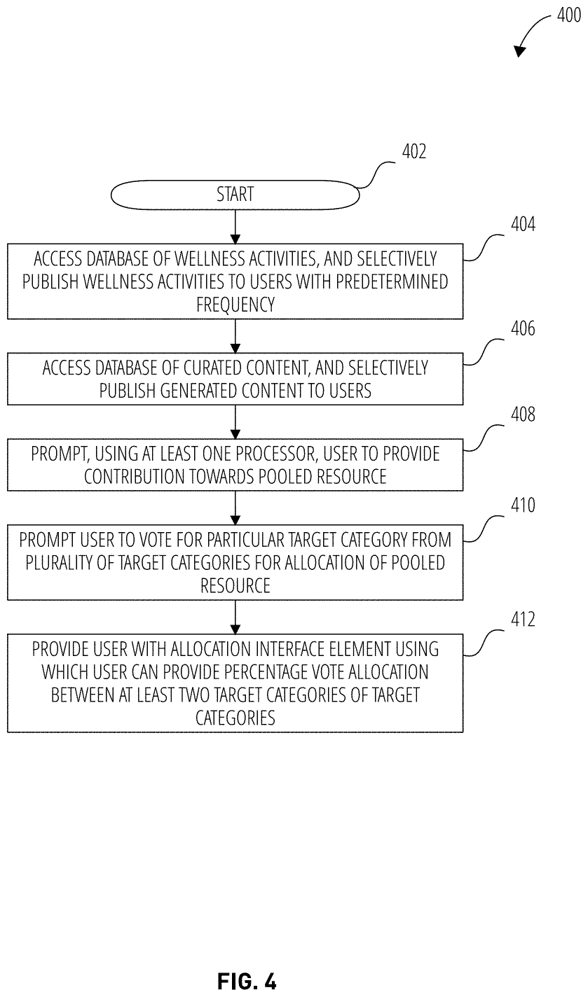

FIG. 4 is a flowchart illustrating a method 400 of resource allocation, in accordance with one example.

The method 400 starts at start block 402. In block 404, the publication system 122 accesses a database of wellness activities (e.g., the activity table 204), and selectively publishes the wellness activities to users with a predetermined frequency in users via the programmatic resource allocation client 108. Specific wellness activities that are published to a specific user 134 may be selected based on information maintained for that user with the user profile table 202 (e.g., interests, previous contributions, or selected categories of charities). The wellness activities are classified, within the database, according to a plurality of wellness topics. The publication system 122 may subscribe a first user to a subscribed wellness topic of the plurality of wellness topics, and selectively publish the wellness activities to the first user from the subscribed wellness topic. A subset of the wellness activities may prompt a user to undertake a particular wellness activity, and the publication system 122 may receive, from the user, an indication that the particular wellness activity has been completed.

At block 406, the publication system 122 accesses a database of curated content (e.g., the curated content table 208) and selectively publishes the curated content to users. Specific curated content published to a specific user 134 may be selected based on information maintained for that user with the user profile table 202 (e.g., interests, previous contributions, or selected categories of charities). The curated content includes stories regarding positive events

At block 408, the payment system 128 prompts, using at least one processor, a user to provide a contribution towards a pooled resource (e.g., as recorded in the pooled resource table 210). At block 410, the voting system 130 prompts the user to vote for a particular target category from a plurality of target categories for allocation of the pooled resource. This vote may be a binary vote (e.g., yes, no) or a percentage allocation votes. In the case of a percentage allocation vote, at block 412, the voting system 130 provides the user with an allocation interface element using which the user can provide a percentage vote allocation between at least two target categories of the plurality of target categories. The allocation interface element may be a slider.

The pooled resource may be a pooled monetary resource, and the prompt is for the user to make a monetary contribution towards the pooled monetary resource. The plurality of target categories may comprise charitable categories.

The figures that follow provide some examples of user interfaces that may be included in various flows provided the resource allocation application servers 104.

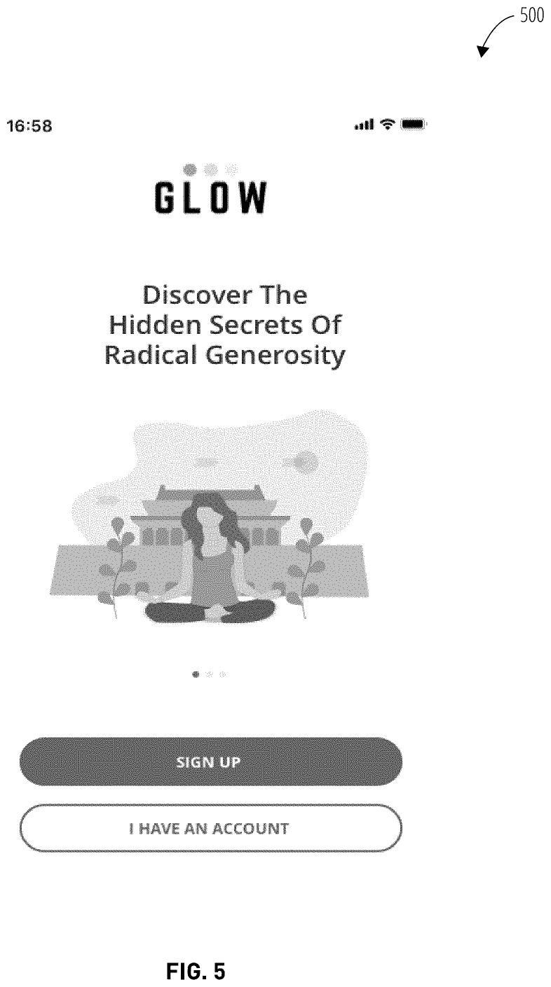

FIG. 5 illustrates a welcome user interface 500 in accordance with one example.

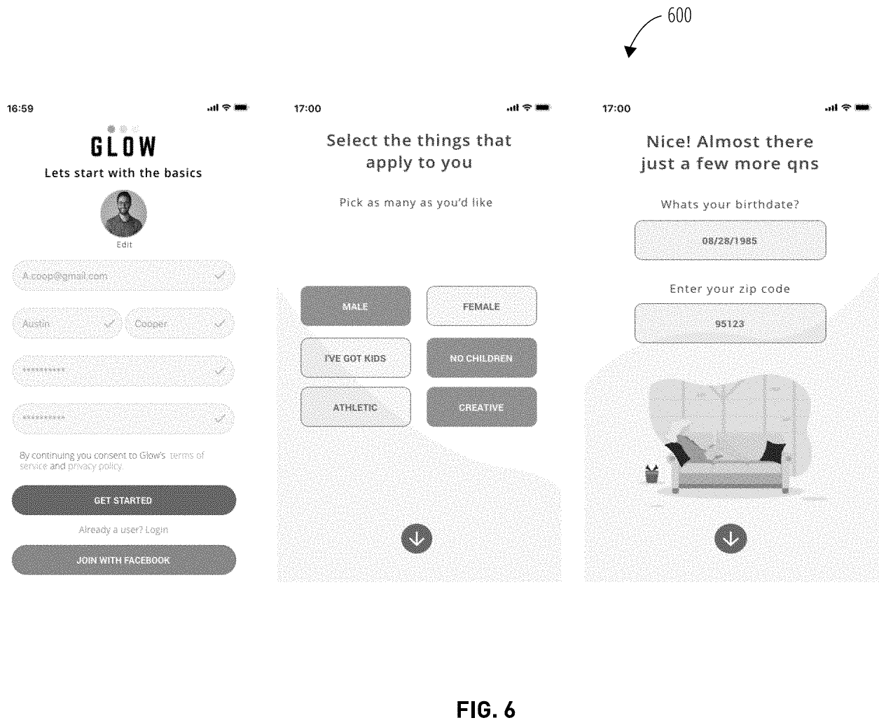

FIG. 6 illustrates a registration user interface sequence 600 in accordance with one example.

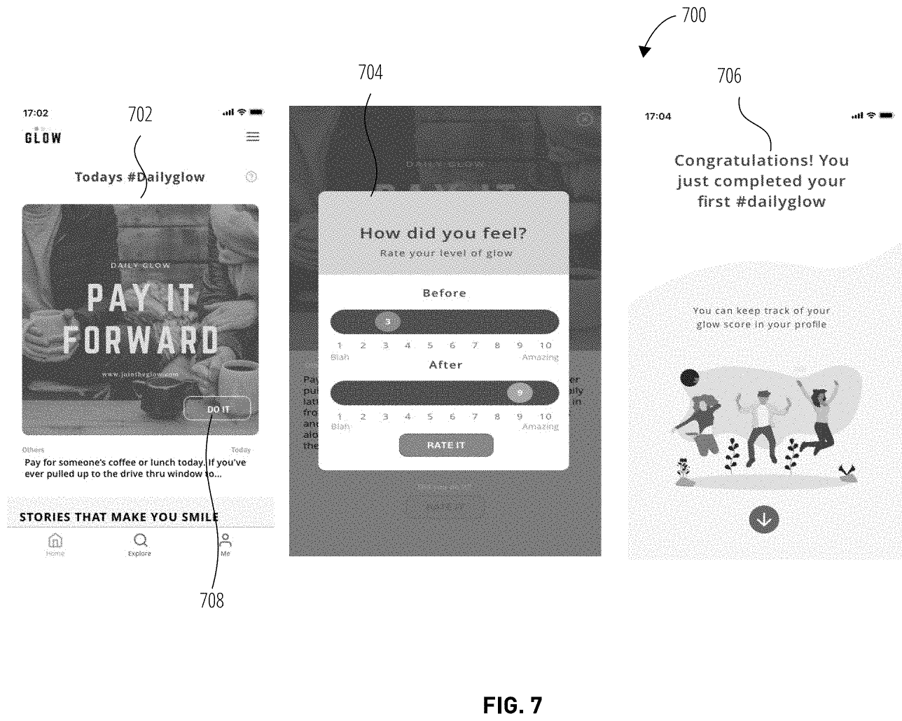

FIG. 7 illustrates a wellness activity user interface sequence 700 in accordance with one example. The wellness activity user interface sequence 700 includes a wellness activities prompt 702 specifying a particular wellness activity (e.g., pay it forward), with an action interface element 708 that is user-selectable to indicate user intention to complete or actual completion of the wellness activity. An activity feedback interface element 704 provides a slider-based feedback mechanism, using which a user can provide information regarding the impact of the wellness activity on an emotional state. Specifically, a user can indicate a level of emotional state before completing the wellness activity and/or after completing the wellness activity. This emotional feedback information may then be included within the user profile of the user (e.g., in the user profile table 202), and also used to rank and rate wellness activities (e.g., within the activity table 204).

A congratulations interface element 706 is then presented to a user after providing the emotional feedback information.

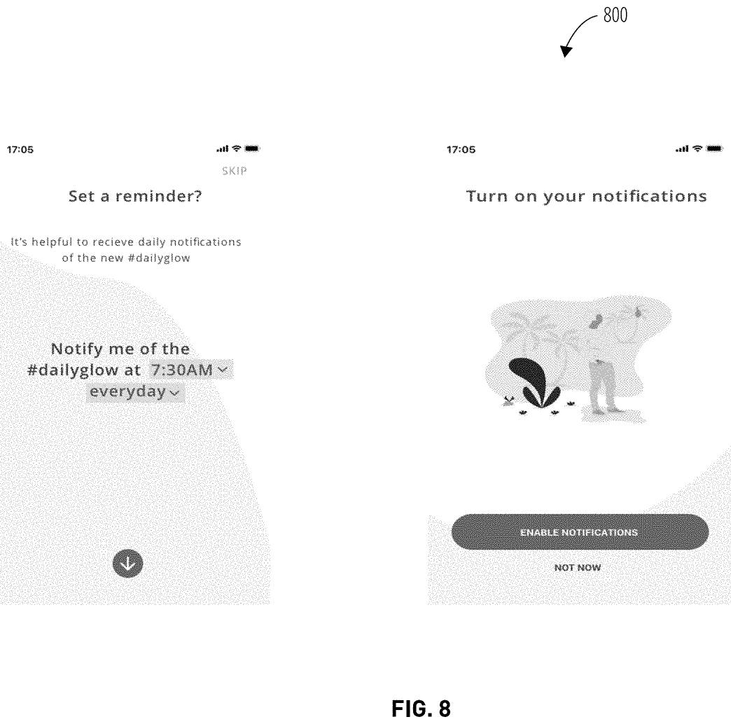

FIG. 8 illustrates a notification user interface sequence 800 in accordance with one example.

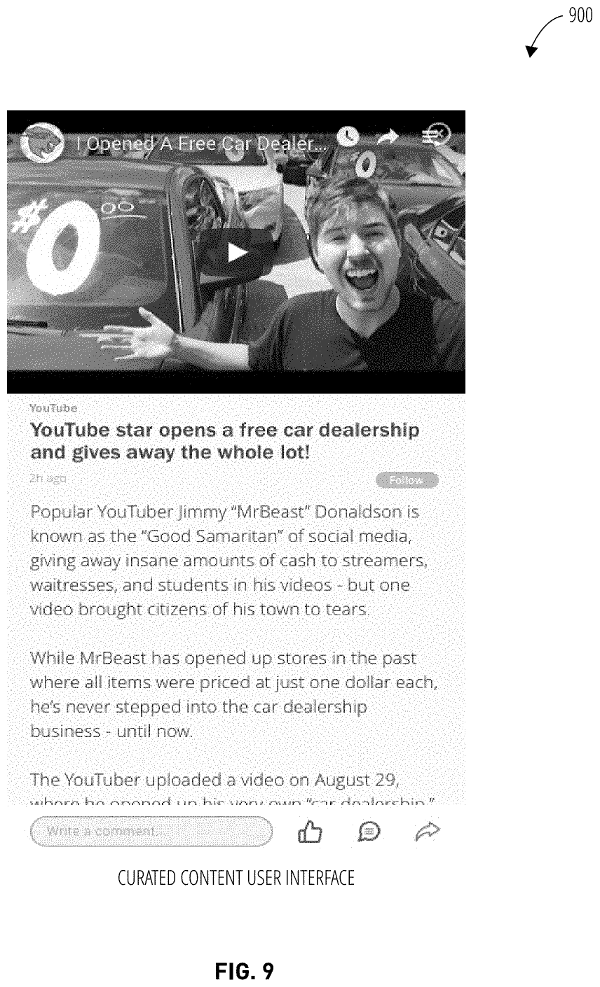

FIG. 9 illustrates a curated content user interface 900 in accordance with one example. The example curated content presented within the curated content user interface 900 is intended to inspire users to perform wellness activities and acts of generosity by highlighting the impact of such activities and acts in curated stories. The curated content may, for example, be selected based on a user profile (in the user profile table 202), as well as other factors such as currency of the content and applicability to the interests (e.g., previous giving/activities) of the relevant user. Additionally, the curated content user interface 900 may present a “follow” button, which is user-selectable to enable a user to follow (e.g., receive updates) regarding a particular story or another aspect of the curated content (e.g., a topic/category in which the curated content is classified, a personality mentioned in the curated content, etc.).

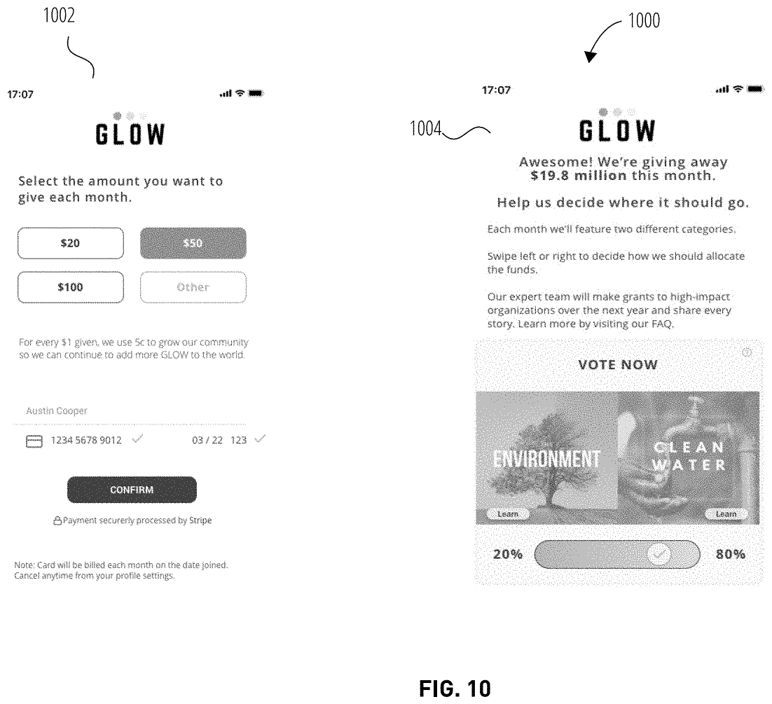

FIG. 10 illustrates an allocation user interface sequence 1000 in accordance with one example. The allocation user interface sequence 1000 includes a resource contribution amount interface element 1002, which presents multiple contributions amounts that a user can optionally select in order to provide on a periodic (e.g., monthly) basis. A voting interface element 1004 includes a voting mechanism that presents one category of resource recipients, and a slider interface element, using which a user can indicate a percentage of their contribution that they vote for allocation to each of multiple recipient categories. In indicate example, a user has indicated that 80% of a monthly contribution should be directed towards “clean water” organizations or charities and that 20% of a monthly contribution should be directed to “environment” organizations or charities. This voting information is stored by the publication system 122 within the vote table 212 within the databases 132.

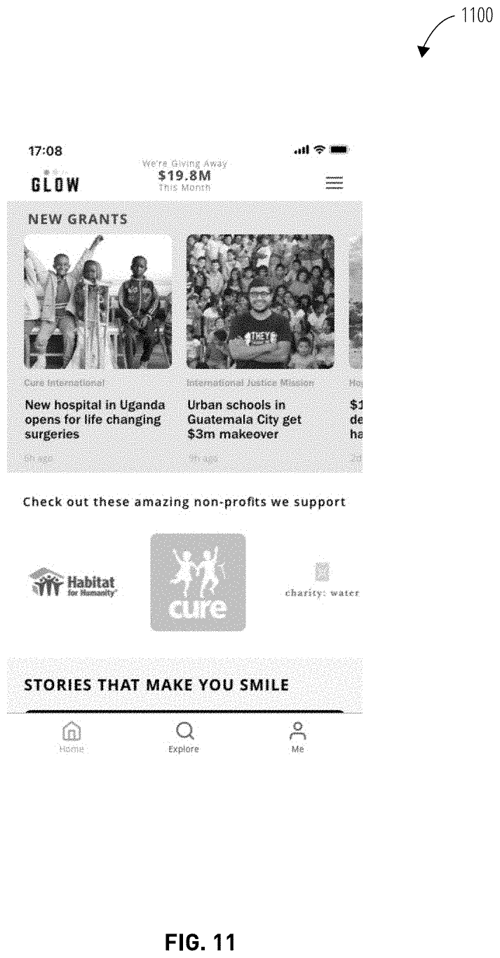

FIG. 11 illustrates a curated content user interface 1100 in accordance with one example.

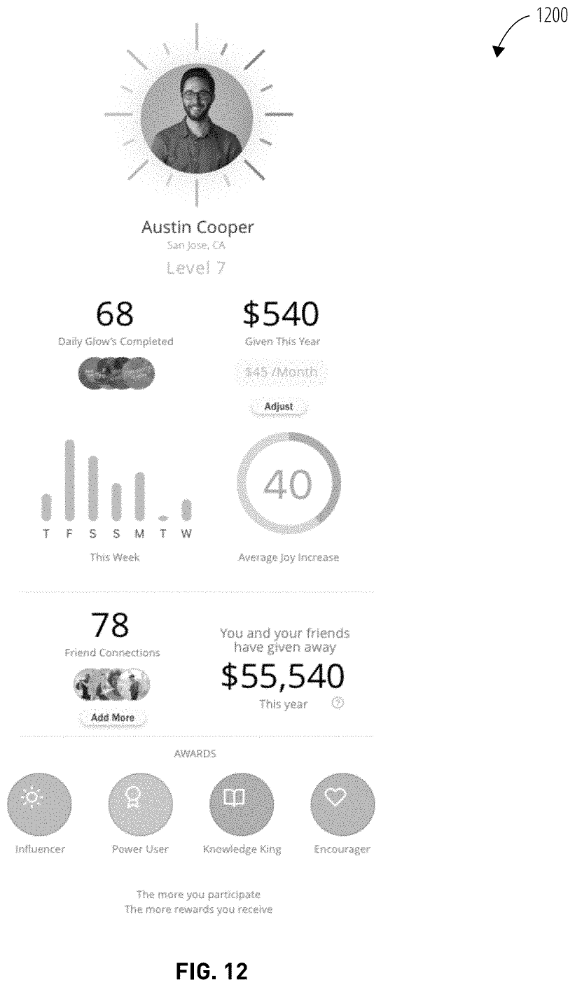

FIG. 12 illustrates a profile user interface 1200 in accordance with one example. The profile user interface 1200 presents various statistics and data items to a user, for example, regarding the user's giving activities and wellness activities. For example, the profile user interface 1200 provides a count of wellness activities (e.g., daily “glows”) that have been completed by a user, as well as dollar totals for monetary giving over a period of time (e.g., a year or a month).

The profile user interface 1200 also presents a bar chart providing a graphical representation of wellness activities completed on a periodic (e.g., daily) basis over a predetermined timeframe (e.g., the preceding week), and also a graphical representation of an “average joy increase,” this being a numeric representation of an estimated increase in the wellness of the user.

Next, the profile user interface 1200 also indicates a number of friend connections for a particular user, this being the number of other users to which the remote user is connected within the profile system 126 (e.g., by an entity graph). Supplementing the social information is a report of a total aggregate monetary value that a user and the relevant user's “friends” or entity connections have given away over a determinable time (e.g., a calendar year, a month, or even a day).

Finally, the profile user interface 1200 also includes an awards section, indicating various awards that have been allocated to the relevant user by the profile system 126. These awards may be automatically calculated and attributed to a user by the profile system 126 upon the user transgressing certain thresholds with respect to activity on the voting system 130 (or other components of the programmatic resource allocation client 108/resource allocation application servers 104), such as the generating of content, the number of daily logins or uses of the application, the number of comments or original content generated by the user on the system, and also the number of “encouragements” or feedbacks provided by a user to other users of the system.

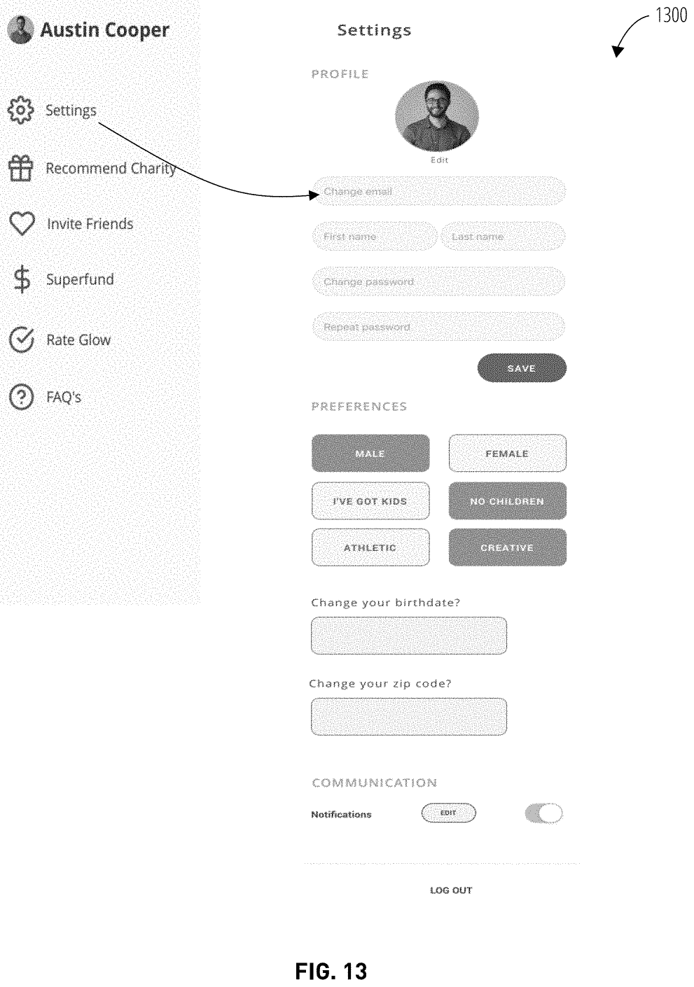

FIG. 13 illustrates a settings user interface 1300 in accordance with one example.

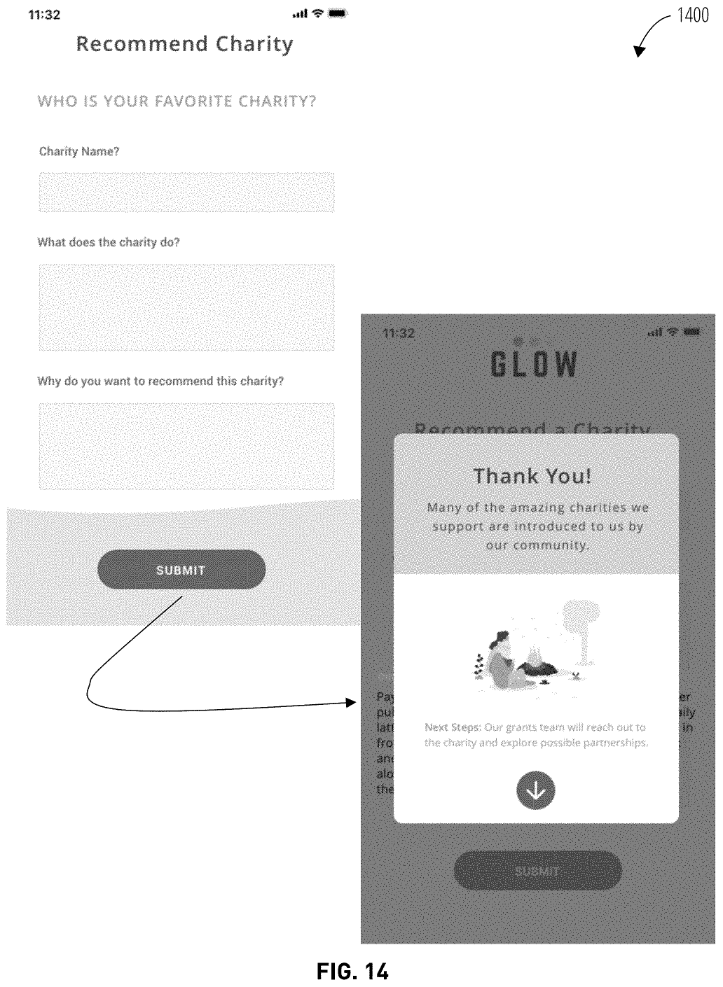

FIG. 14 illustrates a charity recommendation user interface 1400 in accordance with one example.

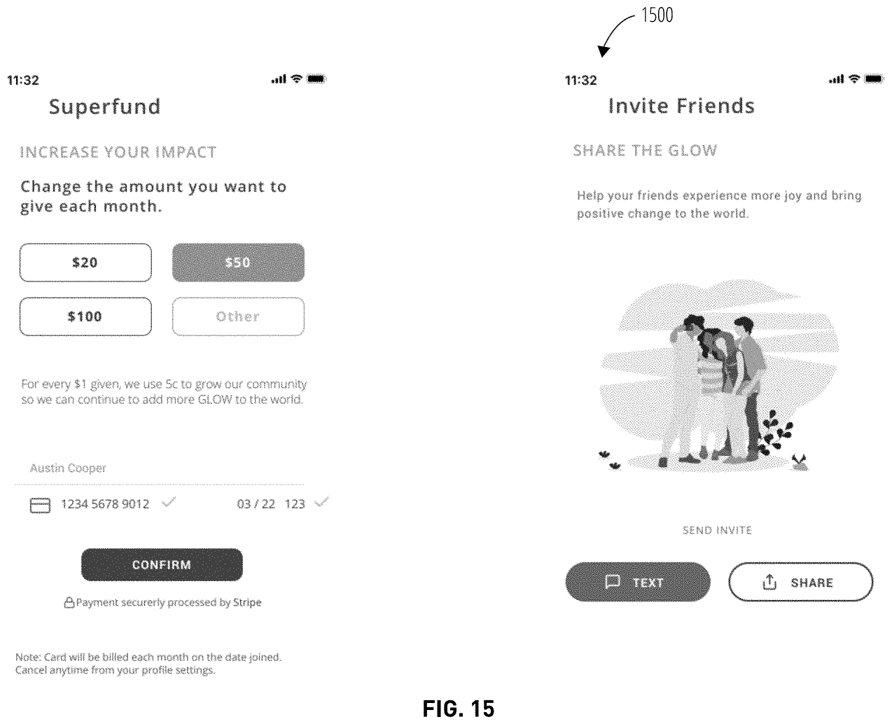

FIG. 15 illustrates an invitation user interface 1500 in accordance with one example.

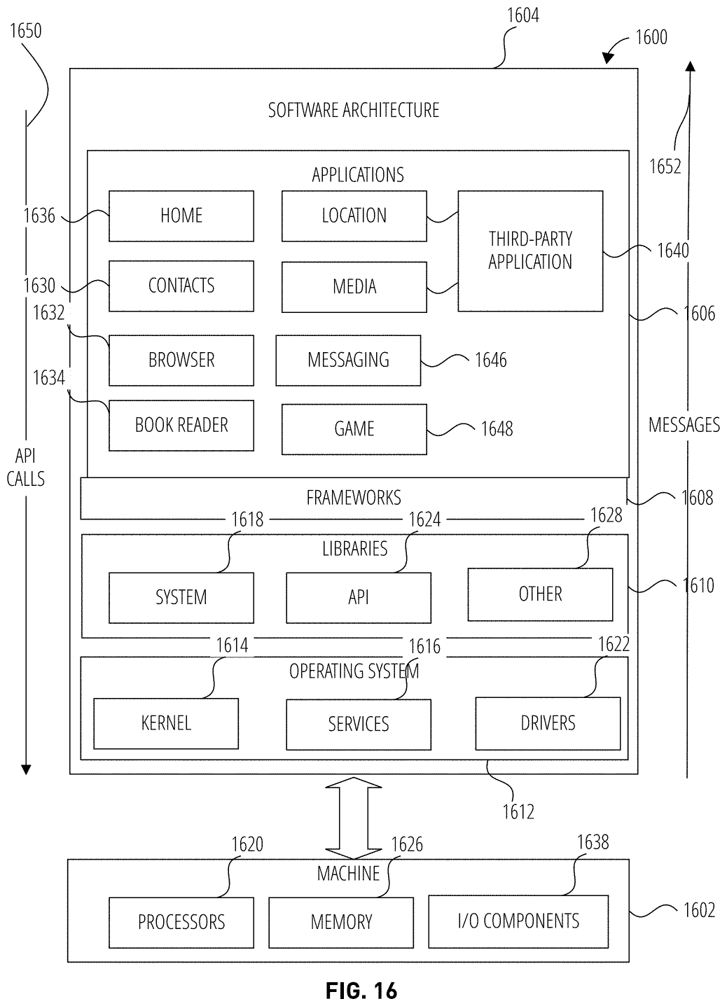

FIG. 16 is a block diagram 1600 illustrating a software architecture 1604, which can be installed on any one or more of the devices described herein. The software architecture 1604 is supported by hardware such as a machine 1602 that includes processors 1620, memory 1626, and I/O components 1638. In this example, the software architecture 1604 can be conceptualized as a stack of layers, where each layer provides a particular functionality. The software architecture 1604 includes layers such as an operating system 1612, libraries 1610, frameworks 1608, and applications 1606. Operationally, the applications 1606 invoke API calls 1650 through the software stack and receive messages 1652 in response to the API calls 1650.

The operating system 1612 manages hardware resources and provides common services. The operating system 1612 includes, for example, a kernel 1614, services 1616, and drivers 1622. The kernel 1614 acts as an abstraction layer between the hardware and the other software layers. For example, the kernel 1614 provides memory management, processor management (e.g., scheduling), component management, networking, and security settings, among other functionality. The services 1616 can provide other common services for the other software layers. The drivers 1622 are responsible for controlling or interfacing with the underlying hardware. For instance, the drivers 1622 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1610 provide a low-level common infrastructure used by the applications 1606. The libraries 1610 can include system libraries 1618 (e.g., C standard library) that provide functions such as memory allocation functions, string manipulation functions, mathematic functions, and the like. In addition, the libraries 1610 can include API libraries 1624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1610 can also include a wide variety of other libraries 1628 to provide many other APIs to the applications 1606.

The frameworks 1608 provide a high-level common infrastructure that is used by the applications 1606. For example, the frameworks 1608 provide various graphical user interface (GUI) functions, high-level resource management, and high-level location services. The frameworks 1608 can provide a broad spectrum of other APIs that can be used by the applications 1606, some of which may be specific to a particular operating system or platform.

In an example embodiment, the applications 1606 may include a home application 1636, a contacts application 1630, a browser application 1632, a book reader application 1634, a location application 1642, a media application 1644, a messaging application 1646, a game application 1648, and a broad assortment of other applications such as a third-party application 1640. The e applications 1606 are programs that execute functions defined in the programs. Various programming languages can be employed to create one or more of the applications 1606, structured in a variety of manners, such as object-oriented programming languages (e.g., Objective-C, Java, or C++) or procedural programming languages (e.g., C or assembly language). In a specific example, the third-party application 1640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1640 can invoke the API calls 1650 provided by the operating system 1612 to facilitate functionality described herein.

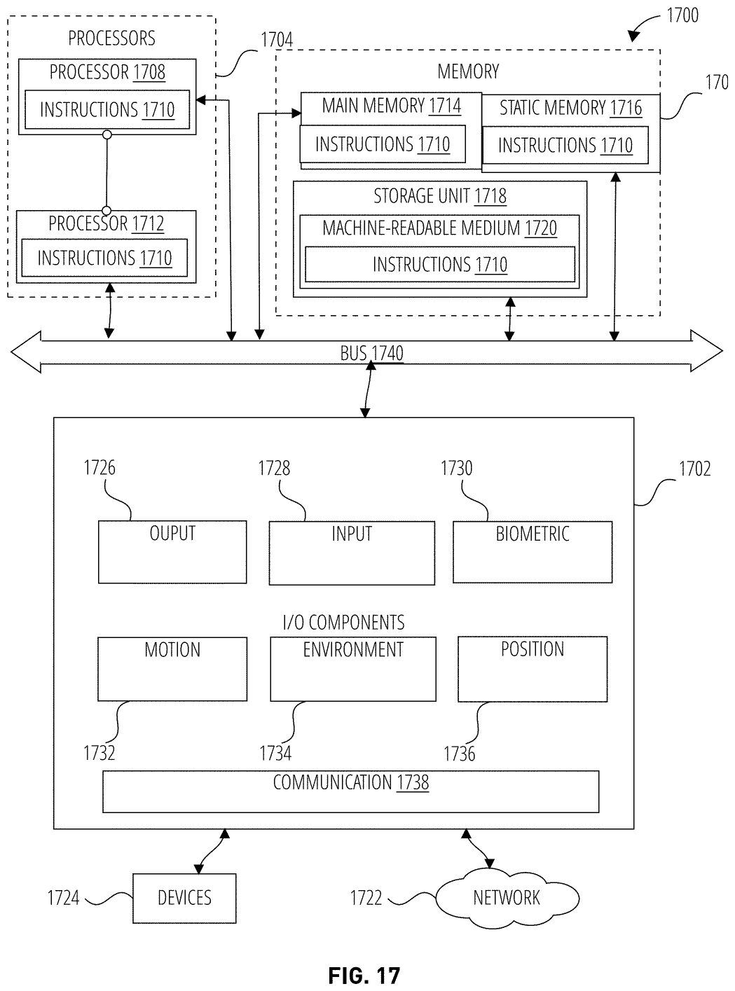

FIG. 17 is a diagrammatic representation of the machine 1700 within which instructions 1710 (e.g., software, a program, an application, an applet, an app, or other executable code) for causing the machine 1700 to perform any one or more of the methodologies discussed herein may be executed. For example, the instructions 1710 may cause the machine 1700 to execute any one or more of the methods described herein. The instructions 1710 transform the general, non-programmed machine 1700 into a particular machine 1700 programmed to carry out the described and illustrated functions in the manner described. The machine 1700 may operate as a standalone device or may be coupled (e.g., networked) to other machines. In a networked deployment, the machine 1700 may operate in the capacity of a server machine or a client machine in a server-client network environment, or as a peer machine in a peer-to-peer (or distributed) network environment. The machine 1700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1710, sequentially or otherwise, that specify actions to be taken by the machine 1700. Further, while only a single machine 1700 is illustrated, the term “machine” shall also be taken to include a collection of machines that individually or jointly execute the instructions 1710 to perform any one or more of the methodologies discussed herein.

The machine 1700 may include processors 1704, memory 1706, and I/O components 1702, which may be configured to communicate with each other via a bus 1740. In an example embodiment, the processors 1704 (e.g., a Central Processing Unit (CPU), a Reduced Instruction Set Computing (RISC) processor, a Complex Instruction Set Computing (CISC) processor, a Graphics Processing Unit (GPU), a Digital Signal processor (DSP), an ASIC, a Radio-Frequency Integrated Circuit (RFIC), another processor, or any suitable combination thereof) may include, for example, a processor 1708 and a processor 1712 that execute the instructions 1710. The term “processor” is intended to include multi-core processors that may comprise two or more independent processors (sometimes referred to as “cores”) that may execute instructions contemporaneously. Although FIG. 17 shows multiple processors 1704, the machine 1700 may include a single processor with a single core, a single processor with multiple cores (e.g., a multi-core processor), multiple processors with a single core, multiple processors with multiples cores, or any combination thereof.

The memory 1706 includes a main memory 1714, a static memory 1716, and a storage unit 1718, both accessible to the processors 1704 via the bus 1740. The main memory 1706, the static memory 1716, and storage unit 1718 store the instructions 1710 embodying any one or more of the methodologies or functions described herein. The instructions 1710 may also reside, completely or partially, within the main memory 1714, within the static memory 1716, within machine-readable medium 1720 within the storage unit 1718, within at least one of the processors 1704 (e.g., within the processor's cache memory), or any suitable combination thereof, during execution thereof by the machine 1700.

The I/O components 1702 may include a wide variety of components to receive input, provide output, produce output, transmit information, exchange information, capture measurements, and so on. The specific I/O components 1702 that are included in a particular machine will depend on the type of machine. For example, portable machines such as mobile phones may include a touch input device or other such input mechanisms, while a headless server machine will likely not include such a touch input device. It will be appreciated that the I/O components 1702 may include many other components that are not shown in FIG. 17. In various example embodiments, the I/O components 1702 may include output components 1726 and input components 1728. The output components 1726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1702 may include biometric components 1730, motion components 1732, environmental components 1734, or position components 1736, among a wide array of other components. For example, the biometric components 1730 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1732 include acceleration sensor components (e.g., accelerometer), gravitation sensor components, rotation sensor components (e.g., gyroscope), and so forth. The environmental components 1734 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1702 further include communication components 1738 operable to couple the machine 1700 to a network 1722 or devices 1724. For example, the communication components 1738 may include a network interface component or another suitable device to interface with the network 1722. In further examples, the communication components 1738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1724 may be another machine or any of a wide variety of peripheral devices (e.g., a peripheral device coupled via a USB).

Moreover, the communication components 1738 may detect identifiers or include components operable to detect identifiers. For example, the communication components 1738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1738, such as location via Internet Protocol (IP) geolocation, location via Wi-Fi® signal triangulation, location via detecting an NFC beacon signal that may indicate a particular location, and so forth.

The various memories (e.g., memory 1706, main memory 1714, static memory 1716, and/or memory of the processors 1704) and/or storage unit 1718 may store one or more sets of instructions and data structures (e.g., software) embodying or used by any one or more of the methodologies or functions described herein. These instructions (e.g., the instructions 1710), when executed by processors 1704, cause various operations to implement the disclosed embodiments.

The instructions 1710 may be transmitted or received over the network 1722, using a transmission medium, via a network interface device (e.g., a network interface component included in the communication components 1738) and using any one of a number of well-known transfer protocols (e.g., hypertext transfer protocol (HTTP)). Similarly, the instructions 1710 may be transmitted or received using a transmission medium via a connection (e.g., a peer-to-peer coupling) to the devices 1724.

Example 1. According to some examples, there is provided a method to allocate pooled resources, the method comprising:

accessing a database of wellness activities, and selectively publishing the wellness activities to users with a predetermined frequency;

accessing a database of curated content, and selectively publishing the generated content to users;

prompting, using at least one processor, a user to provide a contribution towards a pooled resource; and

prompting the user to vote for a particular target category from a plurality of target categories for allocation of the pooled resource.

Example 2. The method of example 1, wherein the wellness activities are classified, within the database, according to a plurality of wellness topics.

Example 3. The method of example 1, including subscribing a first user to a subscribed wellness topic of the plurality of wellness topics, and wherein the selective publication of the wellness activities to the first user is from the subscribed wellness topic.

Example 4. The method of example 1, wherein a subset of the wellness activities prompts a user to undertake a particular wellness activity, the method including receiving, from the user, an indication that the particular wellness activity has been completed.

Example 5. The method of example 1, wherein the curated content includes stories regarding positive events.

Example 6. The method of example 1, wherein the pooled resource is a pooled monetary resource, and the prompt is for the user to make a monetary contribution towards the pooled monetary resource.

Example 7. The method of example 1, wherein the plurality of target categories comprise charitable categories.

Example 8. The method of example 7, wherein the charitable categories comprise one or more of environment, disaster relief; innovation; health, and curing disease.

Example 9. The method of example 1, including providing the user with an allocation interface element using which the user can provide a percentage vote allocation between at least two target categories of the plurality of target categories.

Example 10. The method of example 9, wherein the allocation interface element is a slider.

Example 11. The method of example 9, wherein the curated content relates to contribution recipients of the pooled resource.

Example 12. A computing apparatus, the computing apparatus comprising:

a processor; and

a memory storing instructions that, when executed by the processor, configure the apparatus to:

access a database of wellness activities, and selectively publishing the wellness activities to users with a predetermined frequency;

access a database of curated content, and selectively publishing the generated content to users;

prompt, using at least one processor, a user to provide a contribution towards a pooled resource; and

prompt the user to vote for a particular target category from a plurality of target categories for allocation of the pooled resource.

Example 13. The computing apparatus of example 12, wherein the wellness activities are classified, within the database, according to a plurality of wellness topics.

Example 14. The computing apparatus of example 12, including subscribing a first user to a subscribed wellness topic of the plurality of wellness topics, and wherein the selective publication of the wellness activities to the first user is from the subscribed wellness topic.

Example 15. The computing apparatus of example 12, wherein a subset of the wellness activities prompt a user to undertake a particular wellness activity, the method including receiving, from the user, an indication that the particular wellness activity has been completed.

Example 16. The computing apparatus of example 12, wherein the curated content includes stories regarding positive events.

Example 17. The computing apparatus of example 12, wherein the pooled resource is a pooled monetary resource, and the prompt is for the user to make a monetary contribution towards the pooled monetary resource.

Example 18. The computing apparatus of example 12, wherein the plurality of target categories comprise charitable categories.

Example 19. The computing apparatus of example 18, wherein the charitable categories comprise one or more of environment, disaster relief; innovation; health, and cure disease.

Example 20. The computing apparatus of example 12, including providing the user with an allocation interface element using which the user can provide a percentage vote allocation between at least two target categories of the plurality of target categories.

Example 21. The computing apparatus of example 20, wherein the allocation interface element is a slider.

Example 22. The computing apparatus of example 20, wherein the curated content relates to contribution recipients of the pooled resource.

Example 23. A non-transitory computer-readable storage medium, the computer-readable storage medium including instructions that, when executed by a computer, cause the computer to:

access a database of wellness activities, and selectively publishing the wellness activities to users with a predetermined frequency;

access a database of curated content, and selectively publishing the generated content to users;

prompt, using at least one processor, a user to provide a contribution towards a pooled resource; and

prompt the user to vote for a particular target category from a plurality of target categories for allocation of the pooled resource.

Example 24. The computer-readable storage medium of example 23, wherein the wellness activities are classified, within the database, according to a plurality of wellness topics.

Example 25. The computer-readable storage medium of example 23, including subscribing a first user to a subscribed wellness topic of the plurality of wellness topics, and wherein the selective publication of the wellness activities to the first user is from the subscribed wellness topic.

Example 26. The computer-readable storage medium of example 23, wherein a subset of the wellness activities prompt a user to undertake a particular wellness activity, the method including receiving, from the user, an indication that the particular wellness activity has been completed.

Example 27. The computer-readable storage medium of example 23, wherein the curated content includes stories regarding positive events.

Example 28. The computer-readable storage medium of example 23, wherein the pooled resource is a pooled monetary resource, and the prompt is for the user to make a monetary contribution towards the pooled monetary resource.

Example 29. The computer-readable storage medium of example 23, wherein the plurality of target categories comprise charitable categories.

Example 30. The computer-readable storage medium of example 29, wherein the charitable categories comprise one or more of environment, disaster relief; innovation; health, and cure disease.

Example 31. The computer-readable storage medium of example 23, including providing the user with an allocation interface element using which the user can provide a percentage vote allocation between at least two target categories of the plurality of target categories.

Example 32. The computer-readable storage medium of example 31, wherein the allocation interface element is a slider.

Example 33. The computer-readable storage medium of example 31, wherein the curated content relates to contribution recipients of the pooled resource.

### Glossary

“Carrier Signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Computer-Readable Medium” refers to both machine-storage media and transmission media. Thus, the terms include both storage devices/media and carrier waves/modulated data signals. The terms “machine-readable medium,” “Computer-Readable Medium,” and “device-readable medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines, and/or data. The term shall accordingly be taken to include, but not be limited to, solid-state memories, and optical and magnetic media, including memory internal or external to processors. Specific examples of machine-storage media, computer-storage media, and/or device-storage media include non-volatile memory, including by way of example, semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “Machine-Storage Medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “Signal Medium.”

“Module” refers to logic having boundaries defined by function or subroutine calls, branch points, application program interfaces (APIs), or other technologies that provide for the partitioning or modularization of particular processing or control functions. Modules are typically combined via their interfaces with other modules to carry out a machine process. A Module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processors. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented Module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to and receive information from other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support the performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” refers to any circuit or virtual circuit (a physical circuit emulated by logic executing on an actual processor) that manipulates data values according to control signals (e.g., “commands,” “opcodes,” “machine code,” etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “Signal Medium” shall be taken to include any form of a modulated data signal, carrier wave, and so forth. The term “modulated data signal” means a signal that has one or more of its characteristics set or changed in such a matter as to encode information in the signal. The terms “transmission medium” and “Signal Medium” mean the same thing and may be used interchangeably in this disclosure.

“Wellness activities” refers to any activities that continued towards the wellness, health or well-being of an individual or group of individuals.

What is claimed is:

1. A method to allocate pooled resources, the method comprising:
accessing a database of wellness activities, and selectively publishing the wellness activities to users with a predetermined frequency;
accessing a database of curated content, and selectively publishing the generated content to users;
prompting, using at least one processor, a user to provide a contribution towards a pooled resource; and
prompting the user to vote for a particular target category from a plurality of target categories for allocation of the pooled resource.

2. The method of claim 1, wherein the wellness activities are classified, within the database, according to a plurality of wellness topics.

3. The method of claim 1, including subscribing a first user to a subscribed wellness topic of the plurality of wellness topics, and wherein the selective publication of the wellness activities to the first user is from the subscribed wellness topic.

4. The method of claim 1, wherein a subset of the wellness activities prompts a user to undertake a particular wellness activity, the method including receiving, from the user, an indication that the particular wellness activity has been completed.

5. The method of claim 1, wherein the curated content includes stories regarding positive events.

6. The method of claim 1, wherein the pooled resource is a pooled monetary resource, and the prompt is for the user to make a monetary contribution towards the pooled monetary resource.

7. The method of claim 1, wherein the plurality of target categories comprise charitable categories.

8. The method of claim 1, including providing the user with an allocation interface element using which the user can provide a percentage vote allocation between at least two target categories of the plurality of target categories.

9. The method of claim 8, wherein the allocation interface element is a slider.

10. The method of claim 8, wherein the curated content relates to contribution recipients of the pooled resource.

11. A computing apparatus, the computing apparatus comprising:
a processor; and
a memory storing instructions that, when executed by the processor, configure the apparatus to:
access a database of wellness activities, and selectively publishing the wellness activities to users with a predetermined frequency;
access a database of curated content, and selectively publishing the generated content to users;
prompt, using at least one processor, a user to provide a contribution towards a pooled resource; and
prompt the user to vote for a particular target category from a plurality of target categories for allocation of the pooled resource.

12. The computing apparatus of claim 11, wherein the wellness activities are classified, within the database, according to a plurality of wellness topics.

13. The computing apparatus of claim 11, including subscribing a first user to a subscribed wellness topic of the plurality of wellness topics, and wherein the selective publication of the wellness activities to the first user is from the subscribed wellness topic.

14. The computing apparatus of claim 11, wherein a subset of the wellness activities prompt a user to undertake a particular wellness activity, the method including receiving, from the user, an indication that the particular wellness activity has been completed.

15. The computing apparatus of claim 11, wherein the curated content includes stories regarding positive events.

16. The computing apparatus of claim 11, wherein the pooled resource is a pooled monetary resource, and the prompt is for the user to make a monetary contribution towards the pooled monetary resource.

17. The computing apparatus of claim 11, including providing the user with an allocation interface element using which the user can provide a percentage vote allocation between at least two target categories of the plurality of target categories.

18. The computing apparatus of claim 17, wherein the allocation interface element is a slider.

19. The computing apparatus of claim 17, wherein the curated content relates to contribution recipients of the pooled resource.

20. A non-transitory computer-readable storage medium, the computer-readable storage medium including instructions that, when executed by a computer, cause the computer to:
access a database of wellness activities, and selectively publishing the wellness activities to users with a predetermined frequency;
access a database of curated content, and selectively publishing the generated content to users;
prompt, using at least one processor, a user to provide a contribution towards a pooled resource; and
prompt the user to vote for a particular target category from a plurality of target categories for allocation of the pooled resource.

21. The non-transitory computer-readable storage medium of claim 20.
